(19) United States
(12) Patent Application Publication
(10) Pub. No.: US 2023/0358279 A1
(43) Pub. Date: Nov. 9, 2023

(54) LOCKING MECHANISM FOR SECURING A COUPLING SLEEVE ON A SHAFT

(71) Applicant: Walterscheid GmbH, Lohmar (DE)

(72) Inventors: Bettina Schiffbauer, Lohmar (DE); Martin Hector, Siegburg (DE)

(21) Appl. No.: 18/309,880

(22) Filed: May 1, 2023

(30) Foreign Application Priority Data
May 9, 2022 (EP) 22172259.8

(51) Int. Cl. F16D 1/116

(52) U.S. Cl. CPC F16D 1/116; F16D 2001/103

(57) ABSTRACT

A locking mechanism for securing a coupling sleeve on a shaft, comprises a coupling sleeve with a receptacle extending along a longitudinal axis for receiving a shaft, a plurality of locking elements, each of which is received in a radial aperture of the coupling sleeve so as to be radially movable between a locking position, in which the locking elements project radially inwardly from the apertures into the receptacle for engagement in a circumferential groove of the shaft, and a releasing position, and a locking ring, which is axially adjustable between a closed position and an open position relative to the coupling sleeve, wherein in the closed position a locking section of the locking ring engages around the locking elements radially on the outside and holds them in the locking position. The locking ring is adjustable in the open position between a centered position on the longitudinal axis and an eccentric position parallel to the longitudinal axis, and, in the eccentric position of the locking ring, at least one switching locking element of the plurality of locking elements is located in the locking position and is supported radially outwards against an actuating section of the locking ring, wherein by displacing the at least one switching locking element into the releasing position, the locking ring can be transferred into the centered position via the actuating section.

### CROSS-REFERENCE TO RELATED APPLICATIONS

This application claims priority to European Application No. EP22172259.8, filed on May 9, 2022, which application is hereby incorporated herein by reference in its entirety.

### BACKGROUND

A locking mechanism is described in DE 38 18 808 A1, wherein a spring is provided which spring-loads the locking ring to assume the closed position. The spring is supported on one side against the coupling sleeve and on the other side against the locking ring. The locking mechanism has means for locking the locking ring in the open position and for automatically releasing the locking mechanism when a PTO shaft is inserted into the receptacle of the coupling sleeve. For this purpose, the means for locking have a control ring separate from the locking ring, which in the open position of the locking ring is arranged to be radially movable relative to the latter between a position concentric with the longitudinal axis and a position eccentric with respect to the longitudinal axis. In its position eccentric to the longitudinal axis, a first end of the control ring enters a region of a stop of the coupling sleeve, the locking ring being axially supported against the control ring at a second end thereof. Thus, the locking ring is indirectly supported against the stop via the control ring so that the locking ring is held in a locked open position. The control ring is radially loaded by an adjusting spring to assume the position eccentric to the longitudinal axis and is radially supported against one of the locking elements. If the shaft is now inserted into the receptacle, the locking elements are moved radially outward by the outer contour of the shaft. This also moves the locking element, against which the control ring is supported. The control ring is thus moved radially by this locking element into the position concentric and coaxial to the longitudinal axis. The control ring gets outside the range of the stop, so that the control ring is no longer axially supported against the stop and the spring, which axially loads the locking ring, axially displaces the locking ring and the control ring until the locking ring axially abuts against the locking elements. As soon as the shaft has reached a position, in which the circumferential groove of the shaft is aligned with the radial apertures, the locking elements are transferred radially inwards to their locking position. This is done via the spring, which axially displaces the locking ring and the control ring until the locking ring has reached its closed position, in which the locking ring embraces the locking elements radially on the outside and holds them in the locking position.

A further locking mechanism is described in EP 2 860 419 A2. This locking mechanism has a spring that applies force to a locking ring to assume the closed position. In the open position of the locking ring, the locking ring can be manually tilted relative to the longitudinal axis, with a locking section of the locking ring entering a region of a stop and being axially supported against the stop so that the locking ring is held in the open position against the force of the spring. An actuating section of the locking ring radially covers at least one of the locking elements and holds it in its locking position. When the shaft is pushed into the receptacle, this locking element is moved radially outwards and presses the locking ring back via the actuating section into a position coaxial with the longitudinal axis, in which the locking section is outside the range of the stop and is no longer axially supported against it. Thus, the locking ring is spring-loaded again in the direction of assuming its closed position. However, there is a risk that unintentional contact or contact from the outside with the locking ring could cause it to move to its coaxial position, thus unintentionally releasing the locking mechanism. In addition, it cannot be entirely prevented that the displacement into the coaxial position is caused by shocks or vibrations.

### SUMMARY

Described herein is a locking mechanism for securing a coupling sleeve on a shaft, including a coupling sleeve of a universal joint shaft of an agricultural machine on a (power take-off) PTO shaft of a tractor. It is an aspect of the present disclosure to provide a locking mechanism which is of simple construction.

The locking mechanism comprises a coupling sleeve with a receptacle extending along a longitudinal axis for receiving a shaft, and a plurality of locking elements each received in a radial aperture of the coupling sleeve for radial movement between a locking position, in which the locking elements project radially inwardly from the apertures into the receptacle for engagement in a circumferential groove of the shaft, and a releasing position. Furthermore, the locking mechanism has a locking ring, which is axially adjustable between a closed position and an open position relative to the coupling sleeve, wherein in the closed position a locking section of the locking ring engages around the locking elements radially on the outside and holds them in the locking position. The locking ring is adjustable in the open position between a centered position on the longitudinal axis and an eccentric position parallel to the longitudinal axis. In the eccentric position of the locking ring, at least one switching locking element of the plurality of locking elements is located in the locking position and is supported radially outwards against an actuating section of the locking ring, wherein by displacing the at least one switching locking element into the releasing position, the locking ring can be transferred into the centered position via the actuating section.

A simple locking mechanism with few components required to lock the locking ring is achieved with this locking mechanism design in which the entire locking ring is radially adjustable between the centered position and the eccentric position in which the locking ring is locked in the open position.

In the eccentric position, the locking ring can be axially supported against a locking stop of the coupling sleeve in the direction towards the closed position. This ensures that the locking ring cannot be moved axially into the closed position in its eccentric position, but is fixed in the open position.

In one embodiment of the locking mechanism, the locking mechanism further comprises a housing in which the locking ring is guided in a radially adjustable manner.

Further, the locking mechanism may include first spring means for applying force to the locking ring in the direction towards the closed position. This ensures that in the closed position of the locking ring, the locking elements are held securely in the locking position. The first spring means can be of any design, in particular as a compression spring, for example in the form of a helical spring or disc spring arrangement. A design in the form of an element made of an elastic material, such as rubber or another elastomer, is also conceivable.

The housing can have a receiving space, in which the locking ring is axially immovable or fixed and radially displaceable. The housing can thus be moved axially together with the locking ring relative to the coupling sleeve. The locking ring is protected from external influences so that it cannot be adjusted unintentionally.

The locking mechanism may have second spring means that apply radial force to the locking ring in the direction towards the eccentric position. This allows the locking ring to be held securely in the eccentric position. In addition, when the locking ring is moved axially to the open position, the locking ring is automatically transferred to the eccentric position. No manual intervention is required. The second spring means may be received in the receiving space of the housing.

In an exemplary embodiment of the locking mechanism, the locking mechanism has a spring guide element arranged on the coupling sleeve. The first spring means can be arranged on a sleeve section of the spring guide element and axially supported between a thrust support of the spring guide element and the housing. The first spring means can be axially supported against a shoulder of the coupling sleeve via the thrust support.

In the closed position of the locking ring, the housing can be axially supported against a securing stop on the coupling sleeve. This ensures a defined axial position of the locking ring.

In the closed position of the locking ring, the sleeve section of the spring guide element can be completely covered by the housing. In the open position of the locking ring, the housing can at least partially release the sleeve section of the spring guide element.

Signaling of the position of the locking ring can be effectively achieved by providing the sleeve section of the spring guide element in a signal color, such as for instance red or orange. In the closed position of the locking ring, the sleeve section of the spring guide element is thus not visible from the outside, so that the signal color is not seen. This indicates that the locking mechanism is fully closed. In the open position of the locking ring, on the other hand, the sleeve section of the spring guide element is at least partially not covered by the housing and is thus visible from the outside, so that the signal color can be detected. This indicates to a user that the locking mechanism is open, or not fully closed.

The spring guide element can comprise a guiding element on which the housing is axially displaceably guided, the guiding element being provided in such a way that tilting of the housing relative to the longitudinal axis is prevented. The guiding element can, for example, be provided as a sleeve section of the spring guide element, which is aligned coaxially with the longitudinal axis. Alternatively, it is also conceivable that the guiding element is provided as a component separate from the spring guide element or is provided without a spring guide element. In this case, the guiding element can, for example, be L-shaped or U-shaped in longitudinal section with a sleeve-shaped guide section.

The housing may further include a sleeve-shaped support section that is guided on a cylindrical guide surface of the coupling sleeve over at least a portion of a displacement path of the housing.

If both a guiding element and said sleeve-shaped support section are provided, secure guidance of the housing is ensured, especially if the guiding element and the support section are axially spaced apart. This also results in an extremely secure arrangement against tilting of the housing.

### BRIEF SUMMARY OF THE DRAWINGS

An exemplary embodiment is explained in more detail below using the drawings. Here

FIG. 1 shows a schematic top view of a tractor with attached agricultural machine,

FIG. 2 shows a locking mechanism in longitudinal section in closed position without a shaft,

FIG. 3 shows the locking mechanism according to FIG. 2 in locked open position without a shaft,

FIG. 4 shows the locking mechanism according to FIG. 2 in the unlocked open position with a shaft partially inserted,

FIG. 5 shows the locking mechanism according to FIG. 2 in the closed position with a shaft fully inserted,

FIG. 6 shows the locking mechanism according to FIG. 2 in locked open position with a shaft fully inserted and

FIG. 7 shows a cross-section of the locking mechanism according to FIG. 2.

### DESCRIPTION

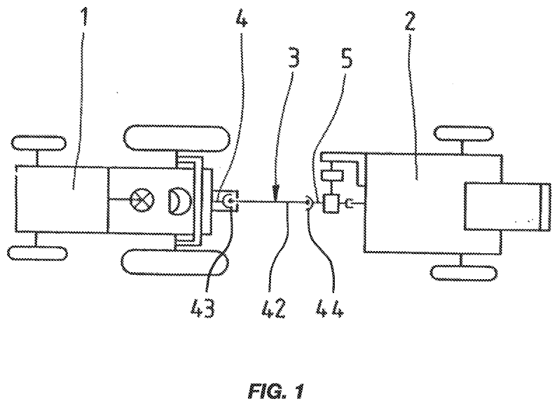

FIG. 1 shows a schematic top view of a tractor 1 with attached agricultural machine 2, whereby the agricultural machine 2 is driven by the tractor 1 via a universal joint shaft 3. For this purpose, the universal joint shaft 3 is drive-connected on the tractor side to a power take-off (PTO) shaft 4 of the tractor 1 via a locking mechanism as described below in a rotationally and axially fixed manner. The power take-off shaft 4 is driven in rotation by the tractor 1. On the agricultural machine side, the universal joint shaft 3 is drive-connected to a drive journal 5 of the agricultural machine 2. A locking mechanism as described below can also be used here. The universal joint shaft 3 may be a conventional cardan shaft with a shaft section 42 which is variable in length and has a cardan joint 43, 44 at each of its two ends. The cardan joints 43, 44 each have an inner yoke connected to the shaft section 42 and an outer yoke connected to the inner yoke by a trunnion cross. A locking mechanism is arranged on at least one outer yoke, as described below. Alternatively, the universal joint shaft 3 can also be formed with at least one constant velocity joint, which can also be provided with a locking mechanism described below.

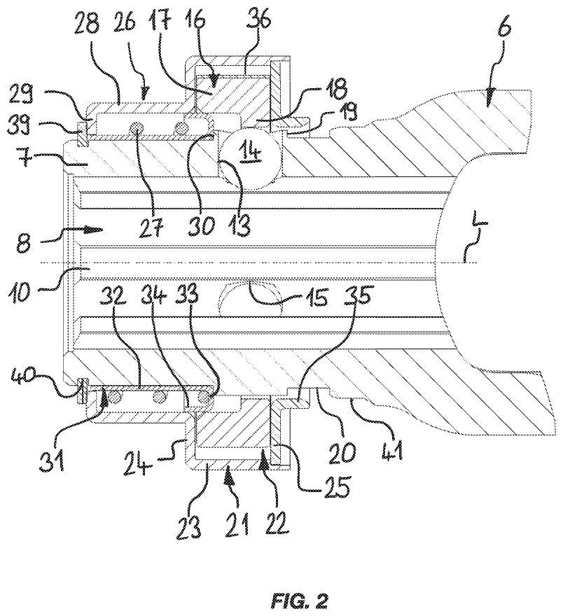

FIGS. 2 to 7 show the locking mechanism in different positions and are described together below.

A coupling sleeve 7 is arranged on an joint yoke 6 (outer yoke). The joint yoke 6 is only partially shown and is connected to a joint yoke (inner yoke), which is not shown for the sake of clarity, via a trunnion cross.

The locking mechanism comprises a coupling sleeve 7 integrally connected to the joint yoke 6 and having a receptacle 8 extending along a longitudinal axis L of the coupling sleeve 7. A shaft 9, in the present case in the form of a power take-off shaft, can be inserted into the receptacle 8 in the direction of the longitudinal axis L. The receptacle 8 has splines 10 formed parallel to the longitudinal axis L and complementary to splines 11 of the shaft 9. This achieves a rotationally fixed connection between the shaft 9 and the coupling sleeve 7 by pushing the shaft 9 into the receptacle 8. The shaft 9 is further formed with a recess in the form of a circumferential groove 12 about the longitudinal axis L, the circumferential groove 12 being represented in the present case only by grooves in a head portion of teeth of the spline 11. In principle, the circumferential groove 12 can also be formed radially deeper.

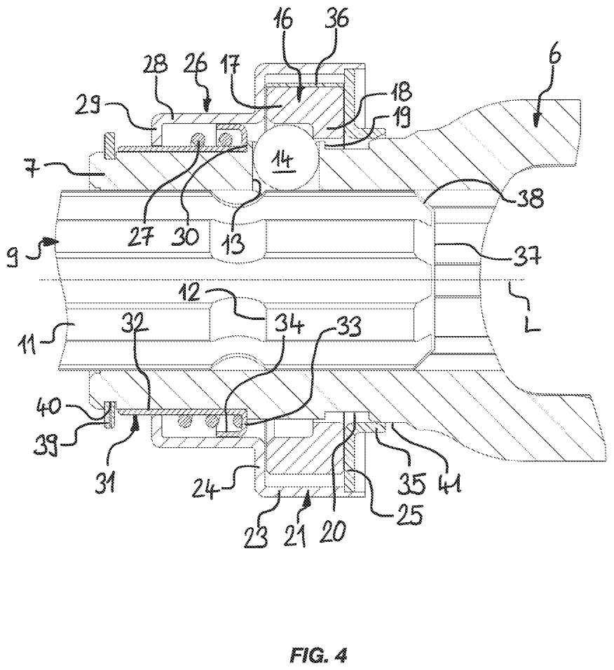

The coupling sleeve 7 has radially extending and circumferentially distributed apertures 13. The apertures 13 completely penetrate the coupling sleeve 7 in the radial direction. A locking element 14 in the form of a ball is arranged in each of the apertures 13 such that it can move radially. The locking elements can also be shaped differently, for example as rollers. The locking elements 14 can be moved between a locking position shown in FIG. 2 and a releasing position shown in FIG. 4. In the locking position, the locking elements 14 project radially inwards from the apertures 13 and can engage in the circumferential groove 12 of the shaft 9 so that the shaft 9 is fixed in the receptacle 8 in an axially secured manner. In the releasing position, the locking elements 14 are displaced radially outwards to such an extent that they do not protrude inwards from the apertures 13 and allow axial movement of the shaft 9. Preferably, three locking elements 14 are arranged distributed over the circumference, although a number deviating from this can also be provided. To secure the radial inward movement, stops 15 are located on the inner sides of the apertures 13, which limit the inward movement of the locking elements 14 so that they cannot fall out of the apertures 13 inwardly when no shaft 9 is inserted into the receptacle 8.

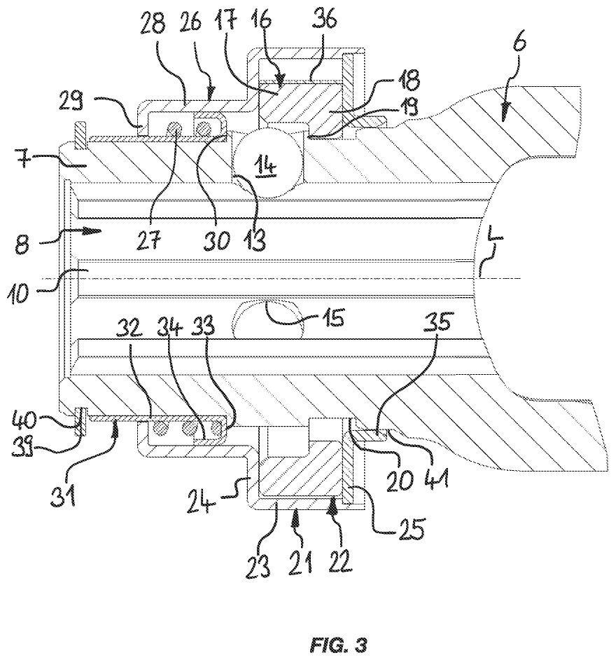

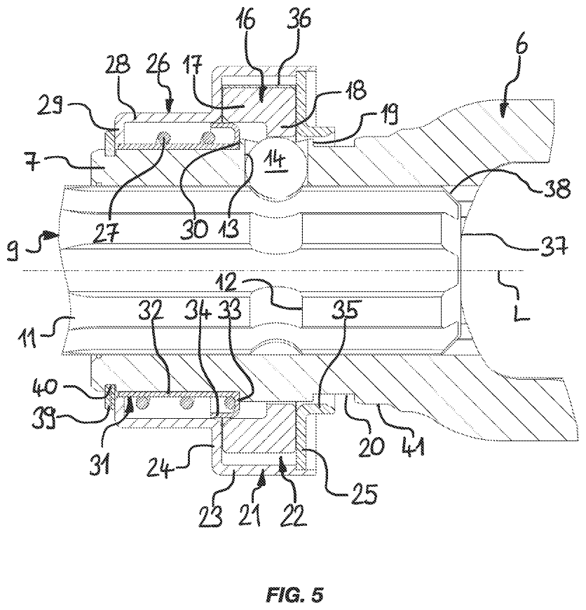

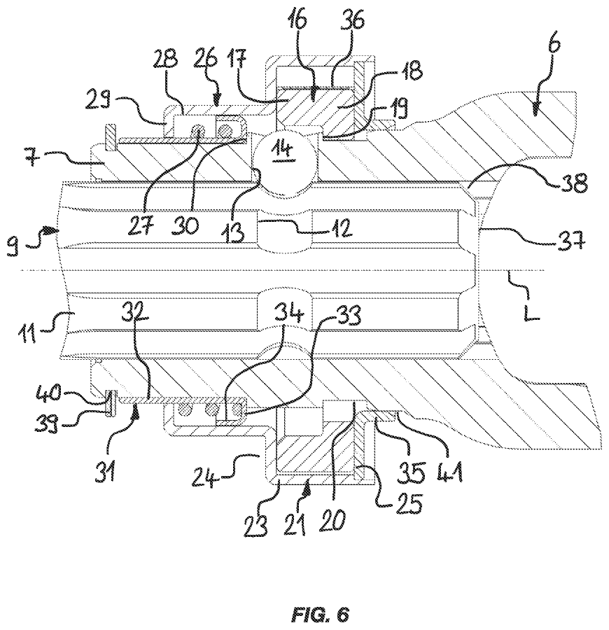

The locking mechanism has a locking ring 16 that is axially movable between a closed position, as shown in FIGS. 2 and 5, and an open position, as shown in FIGS. 3 and 6. The definition of the closed position and the open position refers to the axial position of the locking ring 16 relative to the coupling sleeve 7 and is independent of the radial position of the locking ring 16 relative to the coupling sleeve 7. In the open position, the locking ring 16 is adjustable radially and parallel to the longitudinal axis between a centered position on the longitudinal axis and an eccentric position to the longitudinal axis according to FIGS. 3 and 6.

Viewed in the axial direction, the locking ring 16 has an actuating section 17 and a locking section 18 side by side. The locking section 18 has a smaller inner diameter than the actuating section 17 and thus projects inwardly from the actuating section 17 in a collar shape. In the closed position of the locking ring 16, the locking section 18 is arranged axially overlapping the apertures 13 and the locking elements 14. Thus, the locking section 18 embraces the locking elements 14 radially outside the apertures 13. The inner diameter of the locking section 18 is such that the locking elements 14 are supported radially outwardly against the locking section 18 and continue to project inwardly from the apertures 13. Thus, the locking elements 14 are securely held in their locking position by the locking section 18, as shown in FIGS. 2 and 5. In each case, the radial extent of the locking elements 14 transverse to the longitudinal axis L is greater than the radial extent of the apertures 13.

The locking ring 16 can be moved axially on the coupling sleeve 7 from its closed position in the direction of the joint yoke 6 until the actuating section 17 of the locking ring 16 engages around the locking elements 14. In principle, a mirror image design of the locking ring 16 is also conceivable, in which the locking ring 16 would have to be pushed in the opposite direction from the closed position to the open position. In the open position, the locking elements 14 can move radially out of the apertures 13 until they abut the actuating section 17, so that the locking elements 14 are prevented from exiting the apertures 13 further. In this releasing position, the locking elements 14 no longer protrude inwards from the apertures 13.

A locking stop 19 is provided in the coupling sleeve 7, which is formed as a circumferential, annular surface arranged on a plane perpendicular to the longitudinal axis L. In the embodiment shown, the locking stop 19 is formed by an outer circumferential groove 20 in the coupling sleeve 7. In the eccentric position of the locking ring 16, it is axially supported against the locking stop 19. For this purpose, the locking section 18 comes into contact with the locking stop 19 over part of its circumference, so that the locking ring 16 is prevented from moving in the direction towards the closed position.

The locking mechanism further comprises a housing 21 in which the locking ring 16 is radially adjustably received. The housing 21 forms a receiving space 22 in which the locking ring 16 is guided. The receiving space 22 is annular in shape and is bounded by an outer sleeve-like outer wall 23 and two circular side walls 24, 25, the receiving space 22 being open radially inwardly. The internal spacing between the two side walls 24, 25 is such that the locking ring 16 is not axially adjustable relative to the housing 21, although there may be a slight axial clearance to allow easy radial adjustment transverse to the longitudinal axis. The locking ring 16 is thus received in the housing 21 in an axially non-displaceable and radially displaceable manner.

The housing 21 further includes a spring receiving section 26 in which a compression spring 27 is received as a first spring means. The spring receiving section 26 immediately adjoins the receiving space 22 and is arranged on the side of the receiving space 22 facing away from the joint yoke 6. The spring receiving section 26 is formed by a sleeve-shaped outer wall 28 and a circular side wall 29 projecting radially inwardly from the outer wall 28.

By means of the compression spring 27, the locking ring 16 is spring-loaded in the direction towards its closed position. For this purpose, the compression spring 27 is supported axially on the inside against the side wall 29 of the spring receiving section 26 on the one hand and against a shoulder 30 of the coupling sleeve 7 on the other hand. Thus, force is applied to the housing 21 away from the joint yoke 6 to a position corresponding to the closed position of the locking ring 16. In this position, the housing 21 is axially supported via the side wall 29 of the spring receiving section 26 against a securing stop 39 in the form of a retaining ring arranged in a groove 40 of the coupling sleeve 7. Since the locking ring 16 is arranged axially non-displaceable in the receiving space 22, the locking ring 16 is also axially displaced via the housing 21. The compression spring 27 thus ensures that the locking ring 16 is securely held in its closed position.

In the embodiment shown, the compression spring 27 is indirectly supported against the shoulder 30 via a spring guide element 31. The spring guide element 31 has a sleeve section 32 which is pushed onto the coupling sleeve 7. At an end facing the joint yoke 6, the spring guide element 31 has an thrust support 33 in the form of a circular wall extending radially outwardly from the sleeve section 32. The compression spring 27 is axially supported against the thrust support 33, and the spring guide element 31 is axially supported against the shoulder 30 of the coupling sleeve 7 via the thrust support 33. The thrust support 33 merges into a guide section 34, which serves as a guiding element of the locking mechanism. The guide section 34 is sleeve-shaped and axially overlapping and coaxial with the sleeve section 32. The outer wall 28 of the spring receiving section 26 of the housing 21 is axially guided on the guide section 34, the sleeve-shaped design of the guide section 34 preventing the housing 21 from tilting transverse to the longitudinal axis L. Tilting is further prevented by the side wall 29 of the spring receiving section 26 being guided on the sleeve section 32 of the spring guide element 31. Thus, the housing 21 is securely guided in an axially spaced manner over the side wall 29 of the spring receiving section 26 and the guide section 34 of the spring guide element 31.

Alternatively, it is also conceivable that the guide element is provided as a separate component from the spring guide element 31 or is provided without a spring guiding element 31. In this case, the guiding element can, for example, be L-shaped or U-shaped in longitudinal section with a sleeve-shaped guide section.

A sleeve-shaped support section 35 is further provided on the housing 21 for guiding the housing 21, which is arranged on the side wall 25 facing the joint yoke 6. The support section 35 is axially adjustably guided on a guide surface 41 of the coupling sleeve 7 and serves to further support and prevent tilting of the housing 21, in particular when the housing 21 is in a position corresponding to the open position of the locking ring 16, in which the thrust support 33 and the side wall 29 of the spring receiving section 26 are axially close to each other and thus have less effect against tilting. In this position of the housing 21, the support section 35 is supported on the guide surface 41 of the coupling sleeve 7 on a side of the outer circumferential groove 20 facing the joint yoke 6.

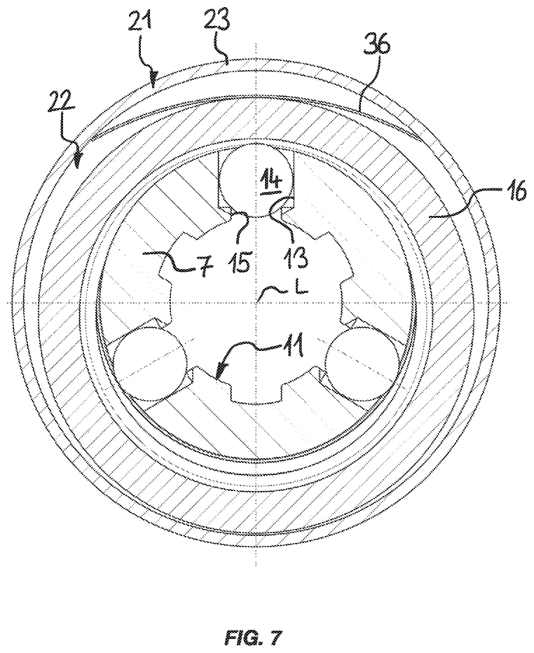

The locking mechanism further includes a leaf spring 36 as a second spring means. The leaf spring 36 biases the locking ring 16 in the direction to assume its eccentric position. For this purpose, the leaf spring 36 is arranged in the receiving space 22 between the outer wall 23 of the receiving space 22 and the locking ring 16. The leaf spring 36 extends around a portion of the circumference of the locking ring 16 and has a smaller curvature than an outer circumferential surface of the locking ring 16. Thus, the leaf spring 36 is supported radially outward at its free ends against the outer wall 23 of the receiving space 22 and is supported inwardly against the locking ring 16 in a central region between the two free ends and biases the locking ring toward the eccentric position, as shown in FIG. 7.

To connect the coupling sleeve 7 to the shaft 9, the locking mechanism can be in the position shown in FIG. 2. This means that the shaft 9 has not yet been inserted into the receptacles 8 and the locking ring 16 is in its closed position, in which the locking elements 14 are secured in their locking position. From this position, the housing 21 can be pulled manually in the direction of the joint yoke 6 against the spring force of the compression spring 27 until the locking section 18 of the locking ring 16 is aligned with the outer circumferential groove 20 of the coupling sleeve 7. In this position, the locking ring 16 is automatically displaced from its centered position to its eccentric position parallel to the longitudinal axis Las the leaf spring 36 applies force to the locking ring 16 to assume the eccentric position. In the eccentric position, a partial circumference of the locking section 18 is located in the outer circumferential groove 20, so that when the housing 21 is released, the locking section 18 comes into contact against the locking stop 19. This is done by the force application of the compression spring 27, which applies force to the housing 21 and thus to the locking ring 16 in the direction towards the closed position. However, reaching the closed position is prevented by the locking section 18 of the locking ring 16 abutting the locking stop 19. The locking ring 16 is thus in the locked open position. In this position, the locking elements 14 are surrounded by the actuating section 17 of the locking ring 16. As a result of the radial displacement of the locking ring 16, a portion of the circumference of the actuating section 17 is closer to the coupling sleeve 7 than a diametrically opposite circumferential portion of the actuating section 17, as can be seen in FIG. 3. This means that the distance between the actuating portion 17 and one of the locking elements 14, which may be referred to as the switching locking element, is less than the distance between the actuating section 17 and the other locking elements 14. In FIG. 3, the locking element 14 located above the longitudinal axis L is the switching locking element 14. The distance between the switching locking element 14 and the actuating section 17 is so small that the switching locking element 14 is always held in a position in which it projects inwardly from the respective aperture 13. The remaining locking elements 14 can be fully immersed in their respective apertures 13.

In this locked open position of the locking ring 16, the coupling sleeve 7 can be pushed onto the shaft 9 or, conversely, the shaft 9 can be pushed into the receptacle 8 of the coupling sleeve 7. The shaft 9 has a central end face 37 at a free end of the shaft 9. The end surface 37 merges radially outwards into slanted surfaces 38, which are arranged on a conical envelope. In other words, the slanted surfaces 38 are arranged at an angle to the longitudinal axis L. When the shaft 9 is pushed into the receptacle 8, the switching locking element 14 is pressed radially outward by one of the slanted surfaces 38 until the switching locking element 14 is fully inserted radially outward into the aperture 13. This presses the switching locking element 14 radially outward against the spring force of the leaf spring 36, so that the locking ring 16 is transferred from its eccentric position to its centered position as shown in FIG. 4. Here, the locking section 18 comes out of engagement with the locking stop 19, so that the spring force of the compression spring 27 applies force to the housing 21 and thus to the locking ring 16 in the direction towards the closed position. In this case, the locking ring 16 can be displaced in the direction towards the closed position until the locking section 18 comes into axial contact against the locking elements 14.

As the shaft 9 is further inserted into the receptacle 8, the circumferential groove 12 of the shaft 9 comes into overlap with the apertures 13 and the locking elements 14. In this position (FIG. 5), the axial force applied by the locking section 18 pushes the locking elements 14 radially inward into the apertures 13 until they protrude internally from the apertures 13 and engage in the circumferential groove 12 of the shaft 9, as shown in FIG. 5. In this position, the shaft 9 is securely fixed axially in the coupling sleeve 7.

To release the coupling sleeve 7 from the shaft 9, the housing 21 is again displaced in the direction towards the joint yoke 6 until the locking section 18 of the locking ring 16 is aligned with the outer circumferential groove 20 of the coupling sleeve 7 and the locking ring 16 engages radially in the outer circumferential groove 20 and is locked against the locking stop 19 after the housing 21 is released. In this position, the shaft 9 can be pulled out of the receptacle 8. Here, the switching locking element 14 is pressed radially outward into the aperture 13 by the outer contour of the shaft 9 until this radially transfers the actuating section 17 and thus the locking ring 16 into the centered position. The shaft 9 is then again in a position as shown in FIG. 4, with the locking ring 16 partially open and not locked. As soon as the shaft 9 is completely pulled out of the exception, the locking ring 16 is transferred back to the closed position due to the spring force of the compression spring 27, resulting in the situation shown in FIG. 2.

### LIST OF REFERENCE NUMBERS

1 Tractor
2 Agricultural machine
3 Universal joint shaft
4 PTO shaft
5 Drive journal
6 Joint yoke
7 Coupling sleeve
8 Receptacle
9 Shaft
10 Spline
11 Spline
12 Peripheral groove
13 Aperture
14 Locking element
15 Stop
16 Locking ring
17 Actuating section
18 Locking section
19 Locking stop
20 Outer circumferential groove
21 Housing
22 Receiving space
23 Outer wall
24 Side wall
25 Side wall
26 Spring receiving section
27 Compression spring (first spring means)
28 Outer wall
29 Side wall
30 Shoulder
31 Spring guide element
32 Sleeve section
33 Thrust support
34 Guide section (guiding element)
35 Support section
36 Leaf spring (second spring means)
37 Front surface
38 Slanted surface
39 Securing stop
40 Groove
41 Guide surface
42 Shaft section
43 Universal joint
44 Universal joint

1-14. (canceled)

15. A locking mechanism for securing a coupling sleeve on a shaft comprising:
a coupling sleeve with a receptacle extending along a longitudinal axis for receiving a shaft;
a plurality of locking elements each of which is received in a radial aperture of the coupling sleeve so as to be radially movable between a locking position, in which the locking elements project radially inwardly from the apertures into the receptacle for engagement in a circumferential groove of the shaft, and a releasing position; and
a locking ring which is axially adjustable between a closed position and an open position relative to the coupling sleeve, wherein in the closed position a locking section of the locking ring engages around the locking elements radially on the outside and holds them in the locking position;
wherein the locking ring is adjustable in the open position between a centered position on the longitudinal axis and an eccentric position parallel to the longitudinal axis; and
wherein, in the eccentric position of the locking ring, at least one switching locking element of the plurality of locking elements is located in the locking position and is supported radially outwards against an actuating section of the locking ring, wherein by displacing the at least one switching locking element into the releasing position, the locking ring is transferrable into the centered position via the actuating section.

16. The locking mechanism of claim 15, wherein the locking ring in the eccentric position is axially supported against a locking stop of the coupling sleeve in the direction towards the closed position.

17. The locking mechanism of claim 15, wherein the locking mechanism comprises a housing in which the locking ring is guided in a radially adjustable manner.

18. The locking mechanism of claim 17, wherein the locking mechanism comprises first spring means that apply force to the locking ring in the direction towards the closed position.

19. The locking mechanism of claim 18, wherein the first spring means are a compression spring.

20. The locking mechanism of claim 17, wherein the housing has a receiving space in which the locking ring is received such that it is not displaceable axially and is displaceable radially.

21. The locking mechanism of claim 17, wherein the locking mechanism comprises second spring means that apply force to the locking ring in the direction towards the eccentric position.

22. The locking mechanism of claim 21, wherein the second spring means are received in the receiving space of the housing.

23. The locking mechanism of claim 18, wherein the locking mechanism comprises a spring guide element arranged on the coupling sleeve;
wherein the first spring means are arranged on a sleeve section of the spring guide element; and
wherein the first spring means are axially supported between a thrust support of the spring guide element and the housing.

24. The locking mechanism of claim 23, wherein the first spring means are axially supported against a shoulder of the coupling sleeve via the thrust support.

25. The locking mechanism of claim 17, wherein the housing is axially supported against a securing stop in the closed position of the locking ring.

26. The locking mechanism of claim 23, wherein the housing completely covers the sleeve section of the spring guide element in the closed position of the locking ring and at least partially exposes it in the open position of the locking ring.

27. The locking mechanism of claim 17, wherein the locking mechanism comprises a guiding element on which the housing is axially displaceably guided.

28. The locking mechanism of claim 17, wherein the housing has a sleeve-shaped support section that is guided on a cylindrical guide surface of the coupling sleeve over at least part of a displacement path of the housing.
